(19) United States
(12) Patent Application Publication
(10) Pub. No.: US 2018/0071763 A1
(43) Pub. Date: Mar. 15, 2018

(54) SHOWERHEAD CLEAINING DEVICE

(71) Applicants: Erin Marie Croghan, Akron, OH (US); Derek Curtis Donohue, Newton, NC (US)

(72) Inventors: Erin Marie Croghan, Akron, OH (US); Derek Curtis Donohue, Newton, NC (US)

(21) Appl. No.: 15/266,139

(22) Filed: Sep. 15, 2016

(51) Int. Cl. B05B 15/02; B65D 43/02; A46B 15/00; B08B 1/00; B08B 3/08

(52) U.S. Cl. CPC B05B 15/025; B65D 43/02; B08B 3/08; B08B 1/002; A46B 15/0091

(57) ABSTRACT

A cleaning device is provided for cleaning pendulous objects. The cleaning device embodies a self-suspending chemically-filled container adapted to circumscribe a portion of the pendulous object to be cleaned so as to securely hang from a remaining portion of the pendulous object. A removable lid of the container provides elastic flaps adapted and dimensioned to receive the portion of the pendulous object so as to frictionally engage the remaining portion thereof, while the flaps prevent leakage of the chemicals within the cavity.

### BACKGROUND OF THE INVENTION

The present invention relates to shower accessories and, more particularly, to a showerhead cleaning device

Calcium and mineral deposits build up and form on showerheads, causing them to not work properly, to back up plumbing, to spray in different directions and/or become difficult to clean. Because of the most problematic mineral buildup takes place within the face apertures of the showerhead, the applicant believes a thorough cleaning inherently involves soaking the showerhead so as to flood the entirety of the face apertures.

Currently, the only other options for cleaning the shower head is to physically remove it from the shower arm, soak it in harsh cleaning solution or replace the entire showerhead all together.

The applicant first tried solving this problem using a makeshift device, for example tying a bag filled with chemicals around the neck of shower head by using a rubber band to secure it thereto. However, applicant has determined this method has the following problems: attaching the bag in such a manner can produce spillage since they are not as stable or convenient to use, wherein the chemical may come in contact with a user's skin or eyes. Likewise, plastic bags are susceptible to breakage or tearing, which would lead to a similar health hazard. Also, rubber bands can fail from the weight and pressure of the cleaning fluids it contains.

As can be seen, there is a need for a showerhead cleaning device that embodies a self-suspending, collapsible chemically-filled container adapted to securely circumscribe so as to hang from the showerhead in situ, whereby the showerhead face cleans in the chemicals, hands-free with no scrubbing involved, and with very little effort or concern of accidently discharging the cleaning fluid.

### SUMMARY OF THE INVENTION

In one aspect of the present invention, a showerhead cleaning device including a container body forming a cavity for receiving contents through a body opening of the container body; a lid adapted to removably secure along the body opening; and a plurality of flaps extending from a periphery of the lid to its center, wherein the plurality of flaps are movable between an extended condition and a circumscribed condition bent into the cavity, wherein the plurality of flaps are biased in the extended condition.

In another aspect of the present invention, the showerhead cleaning device includes a container body forming a cavity for receiving contents through a body opening of the container body; a lid having a central portion and a peripheral portion adapted to removably secure along the body opening, wherein the is made of an elastic material having a predetermined coefficient of friction; a plurality of flaps formed from swirl slits extending from the peripheral portion through the central portion, wherein the plurality of flaps are movable between an extended condition and a circumscribed condition bent into the cavity, wherein the plurality of flaps are biased in the extended condition; a top ring secured along a periphery of the body opening, wherein the top ring provides at least one L-slot dimensioned to align with at least one key element provided by the periphery of the lid, so that the lid moves between an unlocked engagement and locked engagement, wherein the at least one key element slides into the respective at least one L-slot; and a plurality of bristles extending into the cavity from the container body, wherein the container body provides a plurality of fold lines for moving between a collapsed condition and a retracted condition.

In yet another embodiment of the present invention, a method of cleaning a pendulous object includes the steps of: providing the showerhead cleaning device; filling the cavity with a cleaning solution; and urging the pendulous object in the cavity so as to move the plurality of flaps to the circumscribed condition engaging a portion of the pendulous object so as to enable the self-suspension of the device for a predetermined time.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is an exploded bottom perspective view of an exemplary embodiment of the present invention;

FIG. 3 is an exploded top perspective view of an exemplary embodiment of the present invention;

FIG. 4 is a perspective view of an exemplary embodiment of the present invention;

FIG. 5 is an exploded view of an exemplary embodiment of the present invention;

FIG. 6 is a bottom perspective view of an exemplary embodiment of the present invention;

FIG. 7 is a top perspective view of an exemplary embodiment of the present invention;

FIG. 8 is a section view of an exemplary embodiment of the present invention, taken along line 8-8 of FIG. 1;

FIG. 9 is a perspective view of an exemplary embodiment of the present invention;

FIG. 10 is a perspective view of an exemplary embodiment of the present invention;

FIG. 11 is a perspective view of an exemplary embodiment of the present invention; and

FIG. 12 is a section view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a cleaning device for pendulous objects that embodies a self-suspending chemically-filled container adapted to circumscribe a portion of the pendulous object to be cleaned so as to securely hang from a remaining portion of the pendulous object. A removable lid of the container provides elastic flaps adapted and dimensioned to receive the portion of the pendulous object so as to frictionally engage the remaining portion thereof, while the flaps prevent leakage of the chemicals within the cavity.

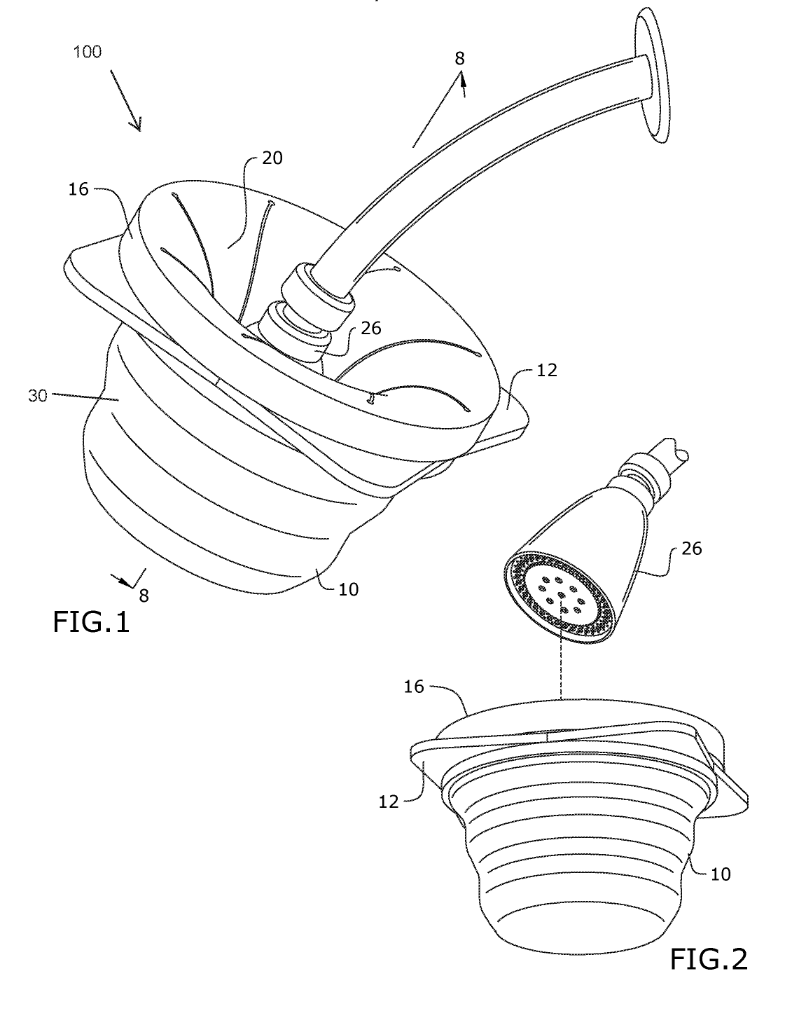

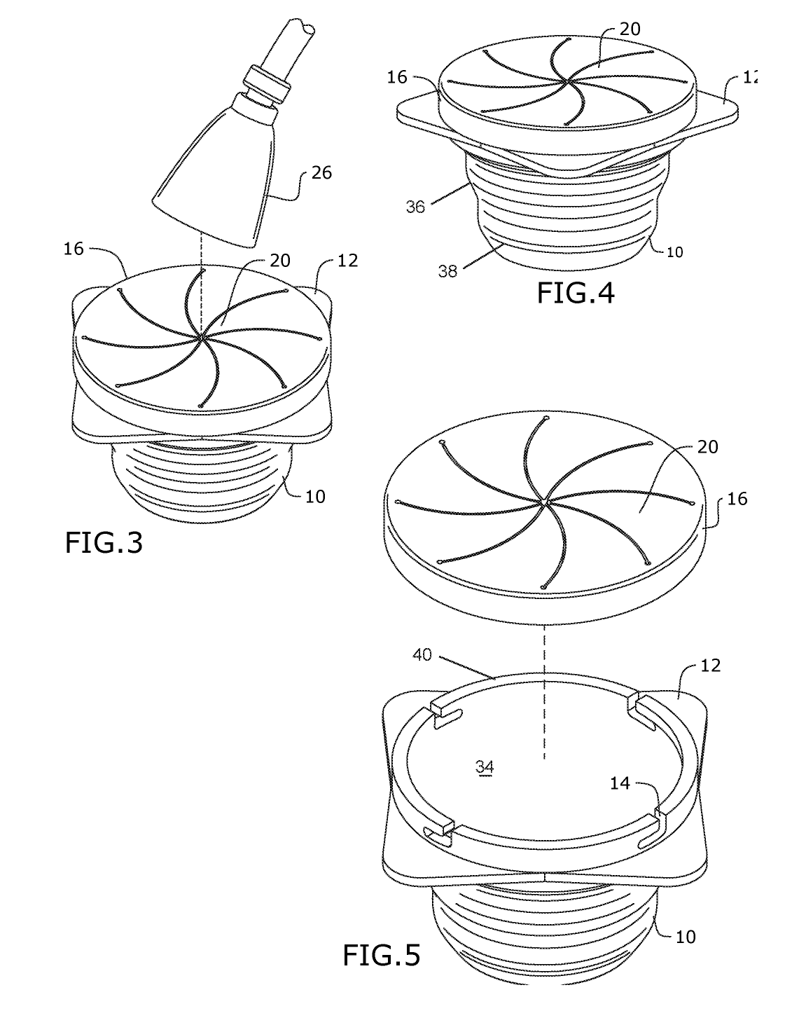

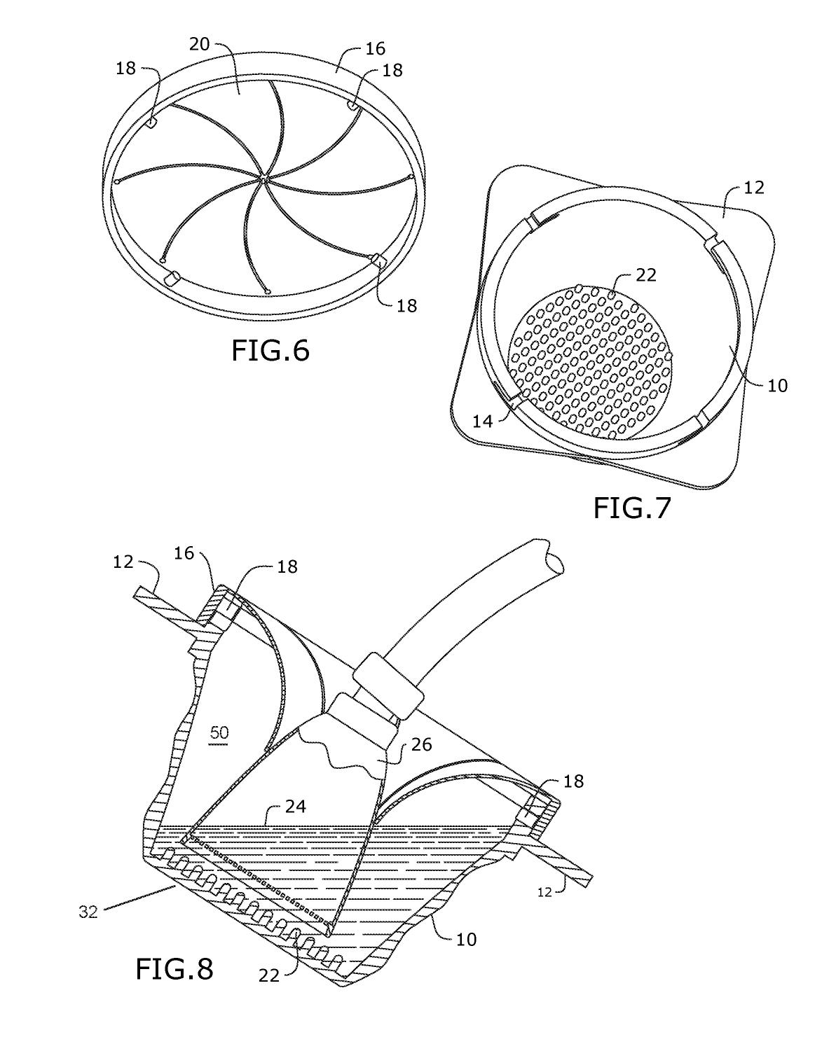

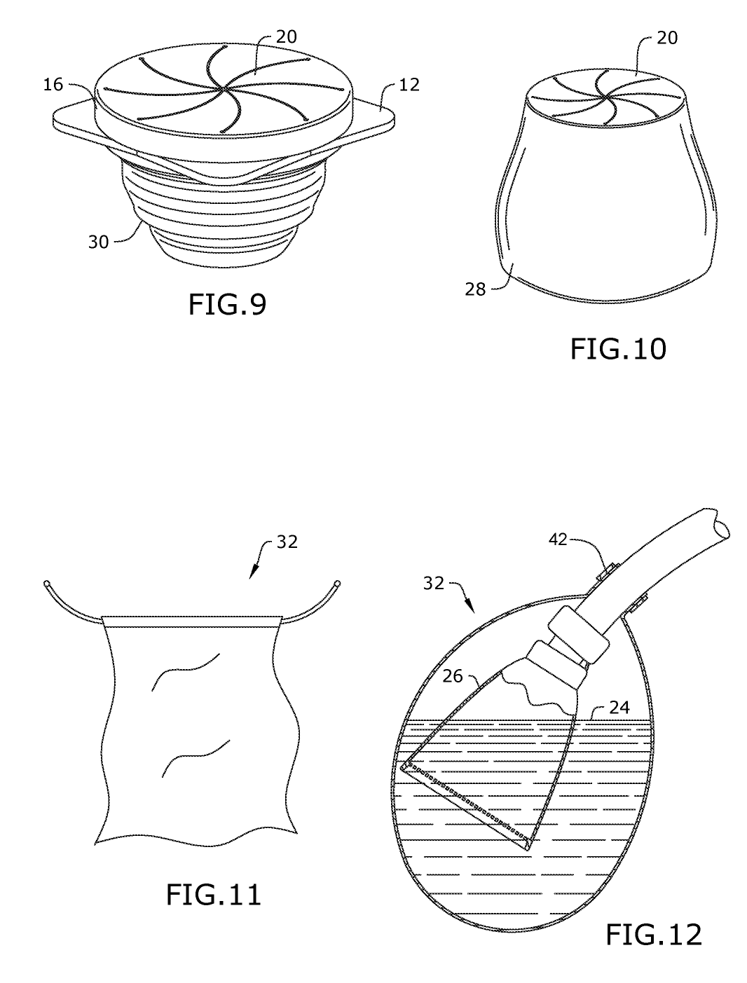

Referring to FIGS. 1 through 9, the present invention may include a cleaning device 100 having a collapsible cup body 10 with a removably connected lid 16, wherein the body 10 forms a cavity 50 for receiving contents 24, and wherein the lid 16 is adapted and dimensioned to seal the cavity 50 along a body opening 34. The body 10 and lid 16 may be made of a rigid polymer polypropylene (PP), Low Density Polyethylene (LDPE), High Density Polyethylene (HDPE), poly(ethylene terephthalate) (PET), and acrylonitrile-butadiene-styrene (ABS), and/or a flexible elastomer, such as silicone, various thermoplastic elastomers, and the like.

The lid 16 may include a plurality of flaps 20 defined by semi-spiral or straight cuts extending from the center of the lid 16 to its periphery. The flaps 20 may be made of flexible elastomer so as to be biased in the extended condition mentioned above, preventing the contents 24 from escaping from the cavity 50, yet allowing an object 26, such as a showerhead face, to pass through the flaps 20 into the cavity 50 in a circumscribed condition, as illustrated in FIG. 1. The biasing of the flaps 20 urges the flap 20 to press against the object 26 as the present invention moves between the extended condition and the circumscribed condition, preventing leakage/spillage of the contents 24 from the cavity 50 during use. This biased urging of the flaps 20 against the object 26 in combination with the elastic material of the flaps 20 may cause sufficient friction there between, supporting the cup body 10 (connected to the lid 16) in the circumscribed condition. The predetermined coefficient of friction may be adapted to apply sufficient static friction under the urging of the biasing to carry the total mass of the body 10, the lid 16 and the cavity filled with water or water-based fluid.

In the circumscribed condition, the object 26 may be in contact with the contents 24, which in certain embodiments, may be cleaning fluid and so the object/shower head face 26 may be submerged therein. The flexible elastomer of the flaps 20 also allow the object 26 to pass there through the lid 16 easily and without scratching.

The body 12 may define the cavity 50 with at least one sidewall 30, a bottom wall 32 and the body opening 34. The body 12 may provide a plurality of bristles 22 extending into the cavity 50. In certain embodiments, the bristles 22 may protrude from the bottom wall 32, opposite the flaps 20, as illustrated in FIG. 8. While the showerhead face soaks in a cleaning solution inside the cavity 50, the bristles 22 may be engaged to remove any remaining residue during the circumscribed condition by simply twisting the body 10 back and forth with an upward motion so as to engage the showerhead face.

A top ring 40 may be provided along the periphery of the body opening 34 so as to removably secure the lid 16 thereto. The top ring 40 may provide at least one L-slot 14 for slidably receiving a complementary at least one key element 18 of the lid 16, so that the lid 16 moves between an unlocked and a locked engagement by way of twisting the key elements from and to the L-slots 14. The cup body 10 may provide circumferential flange handles 12, below the top ring 40.

The cup body 10 may be molded from the rigid polymer or a combination of the rigid polymer and the flexible elastomer. In certain embodiments, the cup body 10 may be made so that the bottom wall 32 and sidewalls 30 are made of rigid polymer, though the sidewall 30 may be co-molded with flexible elastomer so as to make it collapsible. The bottom wall 32, may also include the flexible polymer, if necessary in order for it to collapse. The lid 16 may include the treaded top ring 40 made of rigid polymer, wherein the flaps 20 may be made entirely of molded flexible elastomer. Such a configuration may be made with co-extrusion, wherein the top ring 40 is threaded so as to be securely affixed along the periphery of the body opening 34.

The bristles 22 may be made from the flexible elastomer via die cut from a sheet and affixed to the bottom of the cup via silicone or similar adhesive or added into the mold of the cup body 10 itself. The cup body 10 could be made in a mold or a two-piece mold, wherein first the mold for the cup body 10 would be poured, and then a mold for the lid 16 could also be made. In certain embodiments, both the body 10 and the lid 16 may be made through two-piece injection molding though the lid 16 may also require threading so that the lid 16 can be removed with a quarter turn twist.

Raised rings 36 of a flexible elastomer can be co-molded and added around the circumference of the body sidewall 30 to provide improved grips when applying or removing the cup body 10 as well as and collapsibility.

A method of using the present invention may include the following. The cleaning device 100 disclosed herein may be provided. A user may use the cleaning device 100 for hands-free cleaning of a object 26, such as the face of a showerhead. The contents 24 may include suitable cleaning solution that is poured into the cavity 50 until roughly ⅓ full. In certain embodiments, the contents 24 may include a cleaning pod combine with water. The lid 16 is then twisted until locking engagement. The cleaning device 100 is then pressed upward against the showerhead such that the showerhead face passes through the flaps 20 moving them from the extended condition to the circumscribed condition, immersing the showerhead face in the contents 24. In the circumscribed condition, the flaps 20 frictionally engage the showerhead, as illustrated in FIG. 8, enabling the filled cup body 10 to hold a fixed position relative to the showerhead, whereby the face soaks in the cleaning solution for at least 15 min.

After 15 or so minutes, the cup body 10 can be removed by simply pulling down on the body 10. Additionally, prior to removal, the body 10 can be pushed up against the showerhead/face with a twisting motion, so as to allow the rubber bristles 22 to remove any residue remaining on the shower head prior to removal.

After removing the object 26, the flexible lid 16 may be removed with a twist so the cleaning solution/contents 24 can then be discarded appropriately and makes easy cleaning for the body 10 itself. Then, the user may simply compress down (from the top ring 40 to the bottom wall 32, or vice versa) to collapse the cup body to roughly ⅓ its size for easy storage anywhere. The collapsibility may be made possible by the material, fold lines 38 and/or the raised rings 36 formed along the circumference of the sidewall 30.

Besides showerheads, the object 26 to be soaked can be anything that requires soaking to clean it such as kitchen and bath faucets and garden hose spigots.

The present invention, in alternative embodiments shown in FIGS. 10-12, may provide various body types 28, 32 and bags that are secured to the object 26 through a clip 34, a draw string 32, or the like.

It should be understood, of course, that the foregoing relates to exemplary embodiments of the invention and that modifications may be made without departing from the spirit and scope of the invention as set forth in the following claims.

1. A device, comprising:
a container body forming a cavity for receiving contents through a body opening of the container body;
a lid adapted to removably secure along the body opening; and
a plurality of flaps extending from a periphery of the lid to its center, wherein the plurality of flaps are movable between an extended condition and a circumscribed condition bent into the cavity, wherein the plurality of flaps are biased in the extended condition.

2. The device of claim 1, wherein the plurality of flaps are made of an elastic material having a predetermined coefficient of friction.

3. The device of claim 1, wherein the plurality of flaps are formed by swirl slits through a center portion of the lid.

4. The device of claim 1, further comprising a top ring secured along a periphery of the body opening, wherein the top ring provides at least one L-slot dimensioned to align with at least one key element provided by the periphery of the lid, so that the lid moves between an unlocked engagement and locked engagement, wherein the at least one key element slides into the respective at least one L-slot.

5. The device of claim 1, further comprising a plurality of bristles extending into the cavity from the container body.

6. The device of claim 1, wherein the container body provides a plurality of fold lines for moving between a collapsed condition and a retracted condition.

7. A device, comprising:
a container body forming a cavity for receiving contents through a body opening of the container body;
a lid having a central portion and a peripheral portion adapted to removably secure along the body opening, wherein the lid is made of an elastic material having a predetermined coefficient of friction;
a plurality of flaps formed from swirl slits extending from the peripheral portion through the central portion, wherein the plurality of flaps are movable between an extended condition and a circumscribed condition bent into the cavity, wherein the plurality of flaps are biased in the extended condition;
a top ring secured along a periphery of the body opening, wherein the top ring provides at least one L-slot dimensioned to align with at least one key element provided by the periphery of the lid, so that the lid moves between an unlocked engagement and locked engagement, wherein the at least one key element slides into the respective at least one L-slot; and
a plurality of bristles extending into the cavity from the container body,
wherein the container body provides a plurality of fold lines for moving between a collapsed condition and a retracted condition.

8. A method of cleaning a pendulous object, comprising the steps of:
providing the device of claim 1;
filling the cavity with a cleaning solution; and
urging the pendulous object in the cavity so as to move the plurality of flaps to the circumscribed condition engaging a portion of the pendulous object so as to enable the self-suspension of the device for a predetermined time.
